(19) United States
(12) Patent Application Publication
(10) Pub. No.: US 2025/0296488 A1
(43) Pub. Date: Sep. 25, 2025

(54) VEHICLE SEAT STRUCTURE

(71) Applicant: TOYOTA JIDOSHA KABUSHIKI KAISHA, Toyota-shi (JP)

(72) Inventors: Kohshi KATOH, Hadano-shi (JP); Michio ARAKAWA, Odawara-shi (JP); Ryosuke TANAHASHI, Toyota-shi (JP); Yasushi DOHNOUE, Seto-shi (JP); Koki KUNUGI, Fuji-shi (JP); Masatoshi HADA, Toyota-shi (JP)

(73) Assignee: TOYOTA JIDOSHA KABUSHIKI KAISHA, Toyota-shi (JP)

(21) Appl. No.: 19/005,169

(22) Filed: Dec. 30, 2024

(30) Foreign Application Priority Data
Mar. 22, 2024 (JP) 2024-047144

(51) Int. Cl. B60N 2/66; B60N 2/90; G08B 6/00

(52) U.S. Cl. CPC B60N 2/667; B60N 2/90; G08B 6/00

(57) ABSTRACT

The vehicle seat structure includes a seat back body that extends in the seat width direction and the seat up and down direction and can support a back portion of the occupant, and a central reaction force applying portion that is provided at a portion where the back portion of the occupant comes into contact with the center portion of the seat back body in the seat width direction and is capable of applying a reaction force to the back portion of the occupant in contact with the seat upper side.

### CROSS-REFERENCE TO RELATED APPLICATION

This application claims priority to Japanese Patent Application No. 2024-047144 filed on Mar. 22, 2024, incorporated herein by reference in its entirety.

### BACKGROUND

### 1. Technical Field

The present disclosure relates to a vehicle seat structure.

### 2. Description of Related Art

Japanese Unexamined Patent Application Publication No. 2021-112972 (JP 2021-112972 A) discloses a seat device including a main frame connected to a seat cushion via a reclining shaft, and a subframe swingable in a roll direction relative to the main frame.

### SUMMARY

With the structure described in JP 2021-112972 A, the posture of an occupant can be stabilized by swinging the subframe in accordance with an inertial force acting on the occupant during driving. However, the structure is complicated, and there is room for improvement to achieve widespread use as a seat for a vehicle.

An object of the present disclosure is to provide a vehicle seat structure capable of stabilizing the posture of an occupant during driving with a simple structure.

A vehicle seat structure according to claim 1 includes:
a seat back body extending in a seat width direction and a seat up-down direction and configured to support a back of an occupant; and
a central reaction force applying portion provided at a portion of the seat back body at a center in the seat width direction where the back of the occupant is in contact, and configured to apply a reaction force to the back of the occupant in contact toward a seat upper side.

The vehicle seat structure according to claim 1 includes the seat back body extending in the seat width direction and the seat up-down direction and configured to support the back of the occupant. The central reaction force applying portion is provided at the portion of the seat back body at the center in the seat width direction where the back of the occupant is in contact. The central reaction force applying portion is configured to apply the reaction force to the back of the occupant in contact toward the seat upper side. Therefore, when the occupant brings the upper part of the body into contact with the central reaction force applying portion during driving, a reaction force is applied from the central reaction force applying portion to the backbone of the occupant toward the seat upper side to promote an upright posture of the occupant. Thus, the seating posture can be stabilized.

Since the seating posture can be stabilized only by applying the biased reaction force to the seated occupant toward the seat upper side, a large-scale structure for swinging part of the frame is not required, and the seating posture can be stabilized with a simple structure.

A vehicle seat structure according to claim 2 includes
in claim 1, outer reaction force applying portions arranged on both sides of the central reaction force applying portion in the seat width direction and configured to apply a reaction force to the back of the occupant in contact toward a seat lower side.

In the vehicle seat structure according to claim 2, the reaction force is applied to the back of the occupant toward the seat lower side by the outer reaction force applying portions. By applying the biased reaction forces in the upward and downward directions different from each other by the central reaction force applying portion and the outer reaction force applying portions, it is possible to apply the downward force to the ilium while applying the upward reaction force to the sacrum. As a result, when an external force in the seat width direction is input to the occupant at the time of turning of the vehicle, the upper part of the body moves to a turning outer side, and the head can be guided to a turning inner side by the characteristics of the backbone. Thus, the seating posture at the time of turning can be maintained.

A vehicle seat structure according to claim 3 includes
in claim 2, upper-stage outer reaction force applying portions provided to the seat back body on the seat upper side of the outer reaction force applying portions and configured to apply a reaction force to the back of the occupant in contact toward the seat lower side.

In the vehicle seat structure according to claim 3, when the occupant is a driver, the driver operates the steering wheel at the time of turning, and the upper part of the body is likely to yaw toward the turning inner side. Therefore, the scapula on the turning inner side moves backward. Therefore, the biased reaction force toward the seat lower side is applied to the scapula on the turning inner side from the upper-stage reaction force applying portion. Thus, it is possible to urge the upper part of the body of the occupant to roll toward the turning inner side. As a result, it is possible to take a posture that withstands the external force at the time of turning, and to stabilize the seating posture.

A vehicle seat structure according to claim 4 includes
in claim 2, upper-stage outer reaction force applying portions provided to the seat back body on the seat upper side of the outer reaction force applying portions and configured to apply a reaction force to the back of the occupant in contact toward the seat upper side.

In the vehicle seat structure according to claim 4, when the occupant is a passenger who is seated on a passenger seat or a rear seat and is different from the driver, the upper part of the body of the passenger is likely to yaw toward the turning outer side at the time of turning. Therefore, the scapula on the turning outer side moves backward. Therefore, the scapula on the turning outer side receives the biased reaction force toward the seat upper side from the upper-stage reaction force applying portion. Thus, it is possible to urge the passenger to roll toward the turning inner side relative to the state of the passenger, take a posture that withstands the external force at the time of turning, and stabilize the seating posture.

In a vehicle seat structure according to claim 5,
in any one of claims 1 to 4, the central reaction force applying portion includes a cushion having an S-shaped cross section as viewed in the seat width direction.

In the vehicle seat structure according to claim 5, the biased reaction force is applied by the cushion having the S-shaped cross section. Therefore, the seating posture can be stabilized with a simple structure. In addition, the direction of the biased reaction force to be applied can be reversed only by turning the cushion upside down.

As described above, with the vehicle seat structure of the present disclosure, it is possible to stabilize the posture of the occupant during driving with the simple structure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an enlarged perspective view illustrating a vehicle seat according to an embodiment;

FIG. 2 is an enlarged perspective view illustrating the cushion in the embodiment;

FIG. 3A is an enlarged cross-sectional view of an enlarged portion of a cross-section of a center lower-stage cushion in an unloaded state;

FIG. 3B is an enlarged cross-sectional view of the enlarged portion of the cross-section of the center lower-stage cushion in a compressed state;

FIG. 4A is a front view schematically showing a vehicle seat according to the embodiment, and showing the vehicle seat arranged in a driver's seat;

FIG. 4B is a front view schematically showing the vehicle seat according to the embodiment, and showing the vehicle seat arranged in a passenger's seat;

FIG. 5 is a plan view and a rear view of an occupant of the driver's seat in a left turn;

FIG. 6 is a plan view and a rear view of an occupant of the passenger seat in a left turn;

FIG. 7A is a front view schematically showing a vehicle seat according to a first modification;

FIG. 7B is a front view schematically showing a vehicle seat according to the second modification;

FIG. 7C is a front view schematically showing a vehicle seat according to the third modification;

FIG. 8A is an enlarged cross-sectional view of a main part showing an enlarged cross section of the cushion in the 4 modification;

FIG. 8B is an enlarged cross-sectional view of a main part showing an enlarged cross section of the cushion in the 5 modification; and

FIG. 9 is a cross-sectional view schematically showing a cross section of a vehicle seat according to a sixth modification viewed from a seat width direction.

### DETAILED DESCRIPTION OF EMBODIMENTS

A vehicle seat structure according to an embodiment will be described with reference to the drawings.

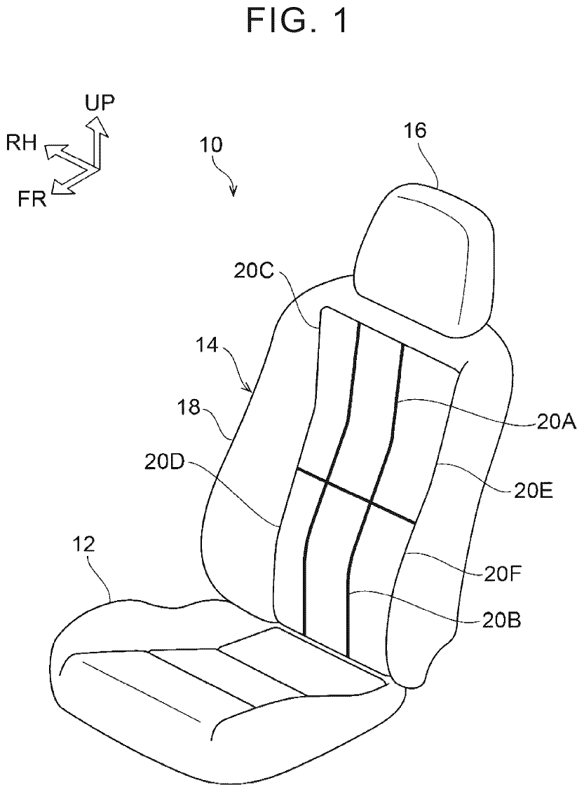

FIG. 1 is an enlarged perspective view illustrating a vehicle seat 10 to which a vehicle seat structure according to an embodiment is applied. Note that the arrow FR, the arrow UP, and the arrow RH in the drawing indicate the seat front direction, the seat upper direction, and the seat right direction of the vehicle seat 10, respectively. In the following description, when the front, rear, up, down, and left and right directions are used without any specific mention, the front and rear directions in the front-rear direction of the seat, the up and down directions of the seat, and the left and right directions of the seat width direction are respectively indicated.

As shown in FIG. 1, the vehicle seat 10 of the present embodiment includes a seat cushion 12, a seat back 14, and a headrest 16. The seat cushion 12 extends in the seat front-rear direction and the seat width direction, and is configured to support the buttocks and thighs of the occupant from below. The seat cushion 12 is supported by a seat rail (not shown), and is configured to be movable in the front-rear direction via the seat rail.

A rear end portion of the seat cushion 12 is connected to the seat back 14. The seat back 14 extends in the seat width direction and the seat up-down direction, and is configured to support the back of the occupant from the rear. A headrest 16 is provided at an upper end portion of the seat back 14. The headrest 16 is configured to support the head of the occupant from the rear.

Here, the seat back 14 includes a seat back body 18 and a cushion 20. In the present embodiment, as an example, six cushions 20 are disposed on the front surface of the seat back 14. The cushion 20 includes a center upper-stage cushion 20A and a center lower-stage cushion 20B disposed at a seat-width-direction central portion. The center upper-stage cushion 20A and the center lower-stage cushion 20B are provided at a portion of the seat back body 18 where the back portion of the occupant comes into contact with the seat width-direction central portion.

Further, a right-side upper-stage cushion 20C is disposed on the right side of the center upper-stage cushion 20A, and a right-side lower-stage cushion 20D is disposed on the right side of the center lower-stage cushion 20B. Further, a left-side upper-stage cushion 20E is disposed on the left side of the center upper-stage cushion 20A, and a left-side lower-stage cushion 20F is disposed on the left side of the center lower-stage cushion 20B.

Each of the six cushions 20 is detachably provided with respect to the seat back body 18. For example, the cushion 20 may be attached to the seat back body 18 by providing a frame body (not shown) on the seat back body 18 and fitting the cushion 20 into the frame body. Further, for example, a hook-and-loop fastener may be provided on each of the seat back body 18 and the cushion 20 so that the hook-and-loop fastener can be attached and detached.

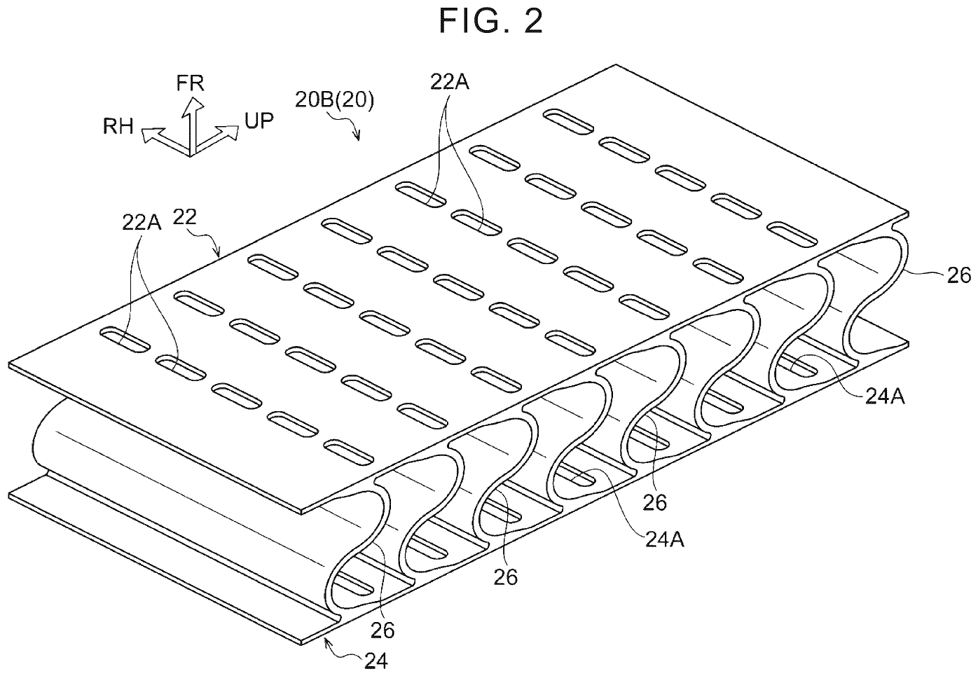

FIG. 2 is an enlarged perspective view illustrating the cushion 20 according to the present embodiment. In the present embodiment, as an example, the six cushions 20 have the same structure.

As shown in FIG. 2, the cushion 20 includes a first base plate portion 22 extending in the seat width direction and the seat up-down direction, and a second base plate portion 24 disposed to face the first base plate portion 22. As shown in FIG. 2, the cushion 20 includes a connecting spring portion 26 that connects the first base plate portion 22 and the second base plate portion 24 in the seat front-rear direction. The cushion 20 has a substantially S-shaped cross section when viewed in the seat width direction.

A plurality of through-holes 22A are formed in the first base-plate portion 22. The through-holes 22A have substantially the same shapes, and are formed in a substantially oval shape having a longitudinal direction in the sheet width direction, and five through-holes 22A are formed at equal pitches in the sheet width direction. In addition, seven through-holes 22A are formed at equal pitches in the vertical direction of the seat.

The second base plate portion 24 has a shape similar to that of the first base plate portion 22, and is spaced apart from the first base plate portion 22 in the seat front-rear direction. In addition, the second base plate portion 24 is formed with a through-hole 24A similar to that of the first base plate portion 22.

Eight connecting spring portions 26 are formed at intervals in the seat vertical direction, and each connecting spring portion 26 extends from one end portion in the seat width direction to the other end portion of the cushion 20. Here, the cushion 20 illustrated in FIG. 2 is, for example, a center lower-stage cushion 20B. The connecting spring portion 26 in the center lower-stage cushion 20B has a substantially S-shape that is curved upward from the first base plate portion 22 toward the second base plate portion 24 and then curved downward. The central reaction force applying portion includes the center lower-stage cushion 20B. In addition, the right-side lower-stage cushion 20D and the left-side lower-stage cushion 20F arranged side by side on both sides in the seat width-direction with respect to the center lower-stage cushion 20B constitute an outer reaction force applying portion.

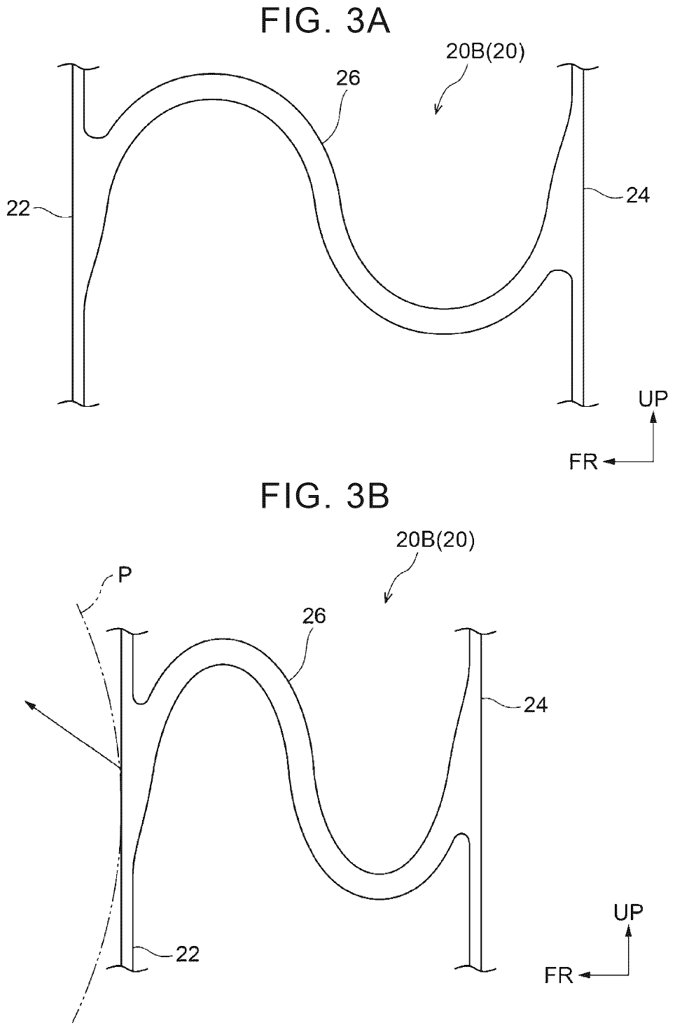

FIGS. 3A and 3B are enlarged cross-sectional views showing a cross-section of the center lower-stage cushion 20B in an enlarged manner, showing a no-load state in FIG. 3A, and a compressed state in FIG. 3B. In the state shown in FIG. 3A, when the first base plate portion 22 is pressed by the body P of the occupant while the second base plate portion 24 is fixed, the state shifts to the state shown in FIG. 3B. That is, the connecting spring portion 26 is compressed and deformed, so that the distance between the first base plate portion 22 and the second base plate portion 24 becomes close.

Here, in the condition shown in FIG. 3B, a reaction force from the first base plate portion 22 toward the front of the seat and upward of the seat acts on the body of the occupant as indicated by an arrow in the drawing. That is, the center lower-stage cushion 20B is configured to be capable of applying a reaction force to the back of the occupant contacting the seat upward.

Here, when the cushion 20 of FIG. 2 is disposed on the opposite side from the front-rear side, the direction of the connecting spring portion 26 is reversed. In this state, since the second base plate portion 24 is positioned on the occupant side, the second base plate portion 24 is pressed toward the first base plate portion 22 side. As a result, a reaction force from the second base plate portion 24 toward the seat front side and the seat lower side acts on the occupant. That is, the cushion 20 is configured so that the direction of the reaction force can be upside down only by arranging the cushion in the upside down direction.

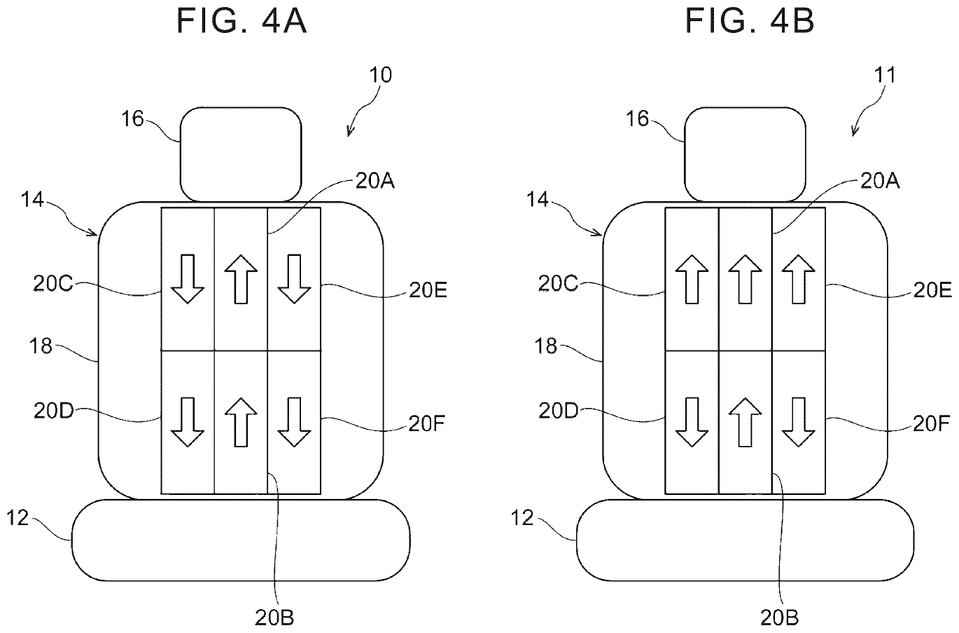

FIGS. 4A and 4B are front views schematically illustrating a vehicle seat 10 according to the embodiment. Specifically, a vehicle seat disposed in the driver's seat is shown in FIG. 4A, and a vehicle seat disposed in the passenger's seat is shown in FIG. 4B.

As shown in FIG. 4A, in the vehicle seat 10 arranged in the driver's seat, the reaction force is different depending on the arrangement of the cushions 20. Specifically, the cushion 20 is attached to the center upper-stage cushion 20A and the center lower-stage cushion 20B in a direction in which a reaction force is applied to the seat upper side. That is, the cushion 20 is attached in a direction in which the first base plate portion 22 is positioned on the seat front side.

The cushion 20 is attached to the right-side upper-stage cushion 20C and the right-side lower-stage cushion 20D in a direction in which a reaction force acts on the seat lower side. That is, the cushion 20 is attached in a direction in which the second base plate portion 24 is positioned on the seat front side.

As with the right-side upper-stage cushion 20C and the right-side lower-stage cushion 20D, the cushion 20 is attached to the left-side upper-stage cushion 20E and the left-side lower-stage cushion 20F in a direction in which a reaction force acts on the seat lower side.

As described above, in the vehicle seat 10 disposed in the driver's seat, the center lower-stage cushion 20B constituting the central reaction force applying portion is configured to apply a reaction force to the back portion of the occupant upward toward the seat. Further, the right-side lower-stage cushion 20D and the left-side lower-stage cushion 20F constituting the outer reaction force applying portion are configured to apply a reaction force to the back portion of the occupant toward the seat lower side.

The right-side upper-stage cushion 20C and the left-side upper-stage cushion 20E disposed on the seat upper side of the right-side lower-stage cushion 20D and the left-side lower-stage cushion 20F constitute an upper-stage outer reaction force applying portion. The upper-stage outer reaction force applying portion is configured to be capable of applying a reaction force to the back portion of the occupant in contact toward the seat lower side.

As shown in FIG. 4B, in the vehicle seat 11 disposed in the passenger seat, the cushion 20 is attached to the center upper-stage cushion 20A and the center lower-stage cushion 20B in a direction in which a reaction force acts toward the seat upper side.

The cushion 20 is attached to the right-side upper-stage cushion 20C in a direction in which a reaction force acts on the seat upper side, and the cushion 20 is attached to the right-side lower-stage cushion 20D in a direction in which a reaction force acts on the seat lower side. That is, the direction of the cushion 20 is changed between the right-side upper-stage cushion 20C and the right-side lower-stage cushion 20D.

The cushion 20 is attached to the left-side upper-stage cushion 20E in a direction in which a reaction force acts on the seat upper side, and the cushion 20 is attached to the left-side lower-stage cushion 20F in a direction in which a reaction force acts on the seat lower side. That is, the left-side upper-stage cushion 20E and the left-side lower-stage cushion 20F are arranged to change the direction of the cushion 20.

As described above, in the vehicle seat 11 disposed in the passenger seat, the right-side lower-stage cushion 20D and the right-side upper-stage cushion 20C and the left-side upper-stage cushion 20E disposed on the seat upper side of the left-side lower-stage cushion 20F, which constitute the outer reaction force applying portion, constitute the upper-stage outer reaction force applying portion. The upper-stage outer reaction force applying portion is configured to be capable of applying a reaction force to the back portion of the occupant in contact toward the seat upper side.

### Operations

Next, the operation of the vehicle seat structure according to the present embodiment will be described.

As shown in FIGS. 3A and 3B, the vehicle seat structure according to the present embodiment includes a seat back body 18 that extends in the seat-width direction and the seat up-down direction and can support the back of the occupant. In addition, a center lower-stage cushion 20B serving as a central reaction force applying portion is provided at a portion of the seat back body 18 where the back portion of the occupant comes into contact with the seat width-direction central portion. Here, the center lower-stage cushion 20B is configured to be capable of applying a reaction force to the back portion of the occupant contacting the center lower cushioning member toward the seat upper side. As a result, when the occupant contacts the spine of the back portion with the center lower-stage cushion 20B during driving, a reaction force is applied from the center lower-stage cushion 20B to the spine of the occupant upward toward the seat. As a result, the standing posture of the occupant is promoted, and the seated posture can be stabilized.

Further, in the present embodiment, the seating posture can be stabilized only by applying the deflection reaction force toward the seat upper side to the seated occupant. Therefore, a large-scale structure for swinging a part of the frame becomes unnecessary, and the seating posture can be stabilized with a simple structure. That is, it is possible to stabilize the attitude of the occupant during driving with a simple structure.

Further, in the present embodiment, the right-side lower-stage cushion 20D and the left-side lower-stage cushion 20F constituting the outer reaction force applying portion apply a reaction force to the seat lower side with respect to the back portion of the occupant. As described above, by applying the deflection reaction force in the vertical direction by the central reaction force applying portion and the outer reaction force applying portion, it is possible to apply the downward force to the ilium while applying the upward reaction force to the sacrum. As a result, when an external force in the seat width direction is input to the occupant at the time of turning of the vehicle, the upper body can be moved to the turning outer side, and the head can be guided to the turning inner side due to the characteristics of the spine, so that the seating posture is stabilized.

This effect will be described, for example, in the case of a left turn traveling on a curve that bends to the left. During a left turn, the upper body of the occupant moves slightly to the outside of the turn (to the right of the seat). As a result, a moment that the pelvis rolls in the vicinity of the lumbar spine is generated by the reaction force from the center lower-stage cushion 20B and the right-side lower-stage cushion 20D. As a result, the spine tends to turn inward (on the left side of the seat), and a moment that supports the upper body toward the inside of the turn is generated. As a result, it is easier to maintain the posture during turning as compared with the vehicle seat where the cushion 20 is not provided.

Further, in the present embodiment, as shown in FIG. 3A, in the vehicle seat 10 disposed in the driver's seat, a reaction force is applied to the back of the occupant (particularly, the vicinity of the scapula) from the right-side upper-stage cushion 20C and the left-side upper-stage cushion 20E toward the seat lower side. This makes it possible to maintain a posture in which the driver can easily withstand the turning external force.

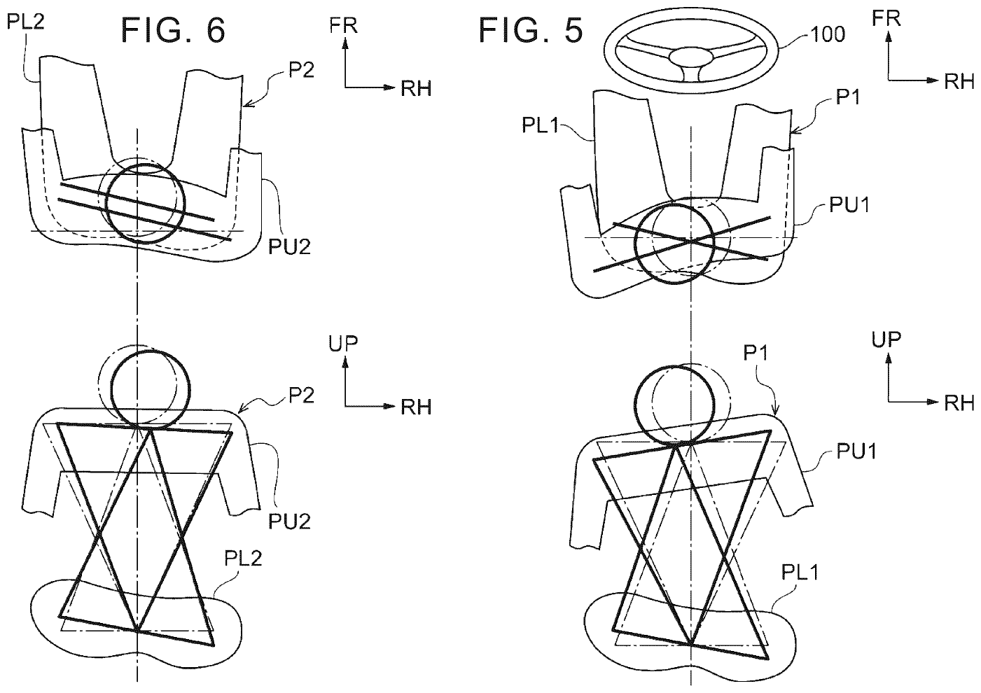

This operation will be described with reference to FIG. 5. FIG. 5 is a plan view and a rear view of the occupant when the driver P1 turns to the left. As shown in this FIG. 5, when the occupant is a driver, the driver P1 operates the steering wheel 100 at the time of turning, so that the upper body PU1 is easily rotated yaw toward the turning inside (the left side of the seat). Therefore, the scapula on the inside of the turning of the driver P1 (on the left side of the seat) is pressed further against the seat back 14, and the deflecting reaction force directed from the left-side upper-stage cushion 20E toward the seat lower side is inputted to the occupant. As a consequence, the upper body PU1 of the driver P1 moves toward the lower body PL1, so that it is possible to urge the driver to roll toward the swivel inner side (the seat left side). That is, it is possible to adopt a posture that withstands an external force during a left turn, and it is possible to stabilize the seating posture of the driver P1.

On the other hand, as shown in FIG. 3B, in the vehicle seat 11 disposed in the passenger seat, a reaction force is applied from the right-side upper-stage cushion 20C and the left-side upper-stage cushion 20E toward the seat upper side with respect to the back of the occupant (particularly, the vicinity of the scapula). This makes it possible to maintain a posture in which the driver can easily withstand the turning external force.

This operation will be described with reference to FIG. 6. FIG. 6 is a plan view and a rear view of an occupant P2 seated in a passenger seat when turning leftward. As shown in FIG. 6, when the occupant P2 is an occupant other than the driver, the upper body PU2 of the occupant P2 easily yaw to the turning outer side (seat right side) when turning. Therefore, the scapula on the turning outer side (seat right side) of the occupant P2 is further pressed against the seat back 14, and a deflecting reaction force directed upward from the right-side upper-stage cushion 20C to the occupant P2 is inputted. Accordingly, the occupant P2 can be stabilized in the seating position by moving the upper body PU2 of the occupant P2 so as to approach the lower body PL2.

Further, in the present embodiment, as shown in FIG. 2, the cushion 20 is formed in a substantially S-shaped cross section when viewed in the seat width direction. This makes it possible to stabilize the seating posture of the occupant with a simple structure. In addition, the direction of the deflection reaction force to be easily applied can be reversed simply by turning the cushion 20 upside down. In addition, by using the same cushion 20, it is not necessary to prepare a dedicated cushion corresponding to the direction of the reaction force, and it is possible to suppress complication of management.

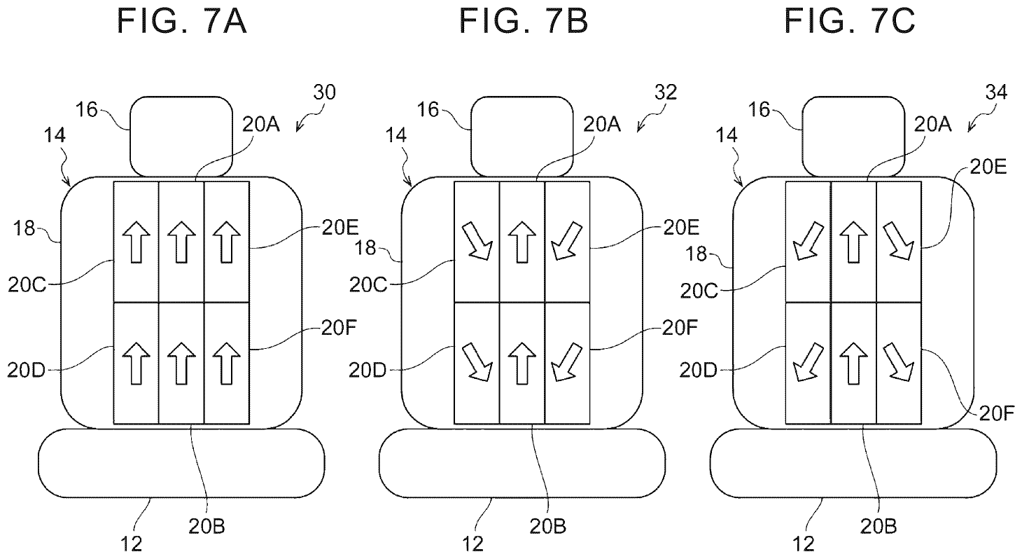

In the present embodiment, the direction of the reaction force is set as shown in FIGS. 4A and 4B, but the present disclosure is not limited thereto. For example, the configuration of the modification shown in FIGS. 7A to 7C may be adopted.

### First Modification

FIG. 7A is a front view schematically showing a vehicle seat 30 according to the first modification, FIG. 7B is a front view schematically showing a vehicle seat 32 according to the second modification, FIG. 7C is a front view schematically showing a vehicle seat 34 according to the third modification.

As shown in FIG. 7A, in the vehicle seat 30 according to the first modification, the center upper-stage cushion 20A and the center lower-stage cushion 20B are mounted in a direction in which a reaction force acts upward of the seat.

The right-side upper-stage cushion 20C and the right-side lower-stage cushion 20D of the vehicle seat 30 are mounted in a direction in which a reaction force acts toward the seat upper side. Further, the cushion 20 is attached to the left-side upper-stage cushion 20E and the left-side lower-stage cushion 20F in a direction in which a reaction force acts toward the seat upper side. That is, in the vehicle seat 30 according to the first modification, all the cushions 20 are mounted in a direction in which a reaction force acts toward the seat upper side.

Even in the case where all the cushions 20 are attached in the same direction as in the present modification example, a reaction force is applied in the direction in which the spine extends, so that a constant posture improving effect can be obtained.

### Second Modification

As shown in FIG. 7B, in the vehicle seat 32 according to the second modification, the center upper-stage cushion 20A and the center lower-stage cushion 20B are mounted in a direction in which a reaction force acts upward of the seat.

The right-side upper-stage cushion 20C and the right-side lower-stage cushion 20D of the vehicle seat 32 are mounted in a direction in which a reaction force acts on the seat lower side and the seat width-direction inner side (seat left side). Further, the cushion 20 is attached to the left-side upper-stage cushion 20E and the left-side lower-stage cushion 20F in a direction in which a reaction force acts on the seat lower side and the seat width-direction inner side (seat right side).

For example, by inclining the extending direction of the connecting spring portion constituting the cushion 20, a reaction force can be applied to the lower side of the seat and the inner side in the seat width direction.

In the present modification, a reaction force from the right-side upper-stage cushion 20C, the right-side lower-stage cushion 20D, the left-side upper-stage cushion 20E, and the left-side lower-stage cushion 20F toward the seat-width-direction inner side acts on the back portion of the occupant. As a result, it is possible to prevent the upper body of the occupant from moving outward when the vehicle turns.

### Third Modification

As shown in FIG. 7C, in the vehicle seat 34 according to the third modification, the center upper-stage cushion 20A and the center lower-stage cushion 20B are mounted in a direction in which a reaction force acts upward of the seat.

The right-side upper-stage cushion 20C and the right-side lower-stage cushion 20D of the vehicle seat 34 are mounted in a direction in which a reaction force acts on the seat lower side and the seat width-direction outer side (seat right side). Further, the cushion 20 is attached to the left-side upper-stage cushion 20E and the left-side lower-stage cushion 20F in a direction in which a reaction force acts on the seat lower side and the seat width-direction outer side (seat left side).

In the present modification, even when a large reaction force is not applied from the cushion 20, such as a relatively small occupant, it is possible to apply a rolling force to the pelvis of the occupant.

### Fourth Modification

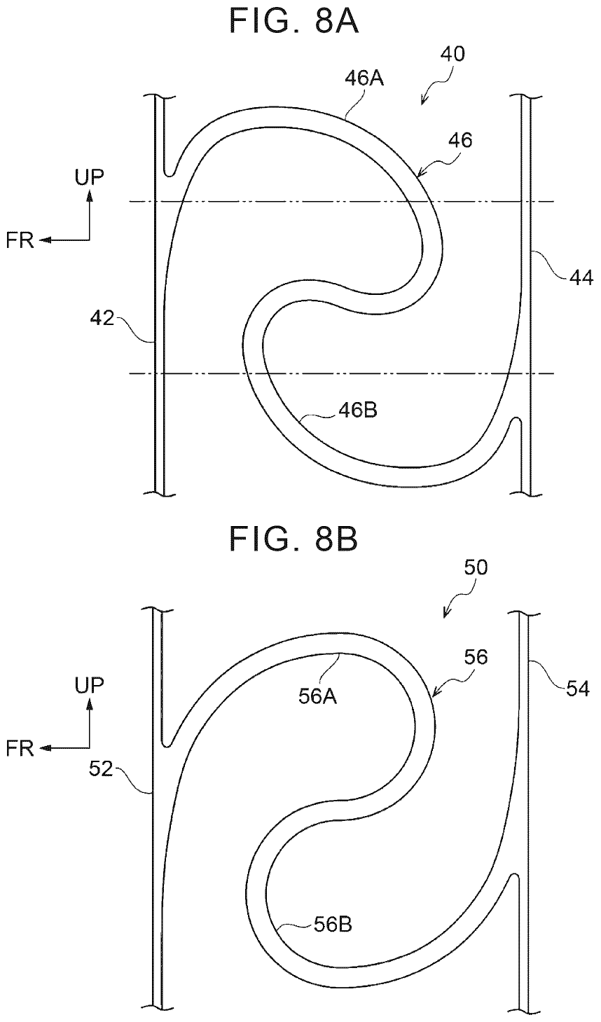

FIG. 8A is an enlarged cross-sectional view of a main part of a cross section of a cushion 40 according to a fourth modification. The cushion 40 of the present modification is configured to include a first base plate portion 42 and a second base plate portion 44 extending in the seat width direction and the seat up-down direction, and a connecting spring portion 46 connecting the first base plate portion 42 and the second base plate portion 44 in the seat front-rear direction.

The connecting spring portion 46 has a substantially S-shaped cross section when viewed in the sheet width direction. Specifically, the connecting spring portion 46 is formed in a substantially S-shape by connecting the first bulging portion 46A bulging from the first base plate portion 42 toward the second base plate portion 44 side and the second bulging portion 46B bulging from the second base plate portion 44 toward the first base plate portion 42 side.

Here, in the connecting spring portion 46 of the present modification, the connecting portion between the first bulging portion 46A and the first base plate portion 42 and the connecting portion between the second bulging portion 46B and the second base plate portion 44 are displaced in the seat up-down direction. That is, an imaginary line extending in the seat front-rear direction from the connecting portion between the first bulging portion 46A and the first base plate portion 42, and an imaginary line extending in the seat front-rear direction from the connecting portion between the second bulging portion 46B and the second base plate portion 44 are displaced in the seat up-down direction.

In this modification, since the connecting portion between the first bulging portion 46A and the first base plate portion 42 and the connecting portion between the second bulging portion 46B and the second base plate portion 44 are displaced in the seat vertical direction, the deflecting reaction force can be adjusted.

### Fifth Modification

FIG. 8B is an enlarged sectional view showing an enlarged cross section of the cushion 50 in the fifth modification. The cushion 50 of the present modification is configured to include a first base plate portion 52 and a second base plate portion 54 extending in the seat width direction and the seat up-down direction, and a connecting spring portion 56 connecting the first base plate portion 52 and the second base plate portion 54 in the seat front-rear direction.

The connecting spring portion 56 has a substantially S-shaped cross section when viewed in the sheet width direction. Specifically, the connecting spring portion 56 is formed in a substantially S-shape by connecting the first bulging portion 56A bulging from the first base plate portion 52 toward the second base plate portion 54 and the second bulging portion 56B bulging from the second base plate portion 54 toward the first base plate portion 52.

In the present modification, the connecting portion between the first bulging portion 56A and the first base plate portion 52 and the connecting portion between the second bulging portion 56B and the second base plate portion 54 are set at substantially the same position in the seat vertical direction.

According to this modification, the gap between the first bulging portion 56A and the second base plate portion 54 is smaller and the gap between the second bulging portion 56B and the first base plate portion 52 is smaller than that of the connecting spring portion 26 of the embodiment. As a result, as compared with the embodiment, when the cushion 50 is compressed, the connecting spring portion 56 easily comes into contact with the first base plate portion 52 and the second base plate portion 54, and a reaction force can be applied at an early stage.

### Sixth Modification

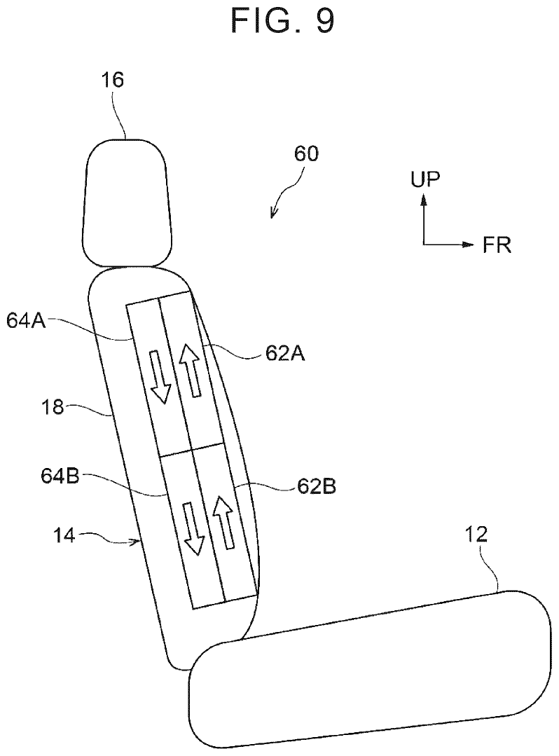

FIG. 9 is a cross-sectional view schematically showing a cross section of a vehicle seat 60 according to a sixth modification viewed from the seat width direction.

As shown in FIG. 9, the vehicle seat 60 according to the present modification is different from the embodiment in that a plurality of cushions are arranged in the thickness direction of the seat back body 18.

The center upper-stage cushion 62A and the center lower-stage cushion 62B are mounted in a direction in which a reaction force acts on the seat upper side. Further, a rear-side center upper-stage cushion 64A is disposed on the seat rear side with respect to the center upper-stage cushion 62A. Further, a rear-side center lower-stage cushion 64B is disposed on the seat rear side with respect to the center lower-stage cushion 62B.

The rear-side center upper-stage cushion 64A and the rear-side center lower-stage cushion 64B are mounted in a direction in which a reaction force acts on the seat upper side.

In this modification, the right-side upper-stage cushion, the right-side lower-stage cushion, the left-side upper-stage cushion, and the left-side lower-stage cushion, which are not shown, may be arranged in the same direction as the embodiment shown in FIG. 4A, or may be arranged in the same direction as the embodiment shown in FIG. 4B.

A rear right-side upper-stage cushion (not shown) is disposed on the right side of the rear-side center upper-stage cushion 64A, and a rear left-side upper-stage cushion (not shown) is disposed on the left side of the rear-side center upper-stage cushion 64A. Further, a rear right-side lower-stage cushion (not shown) is disposed on the right side of the rear-side center lower-stage cushion 64B, and a rear left-side lower-stage cushion (not shown) is disposed on the left side of the rear-side center lower-stage cushion 64B.

The direction of the rear right-side upper-stage cushion, the rear right-side lower-stage cushion, the rear left-side upper-stage cushion, and the rear left-side lower-stage cushion is not particularly limited, and may be the same as or different from the direction of the cushion adjacent to the seat front side.

According to this modification, one cushion of the center upper-stage cushion 62A and the rear-side center upper-stage cushion 64A is formed to be more easily deformed than the other cushion. Accordingly, the direction of the reaction force applied to the occupant can be changed according to the physique of the occupant or the like.

Although the vehicle seat structure according to the embodiment and the modification has been described above, it is needless to say that the vehicle seat structure can be implemented in various forms without departing from the gist of the present disclosure. For example, in the above embodiment, as shown in FIG. 1, six cushions 20 are provided in the seat back body 18, but the present disclosure is not limited thereto, and the number of cushions may be changed. For example, only three cushions 20 of the center lower-stage cushion 20B, the right-side lower-stage cushion 20D, and the left-side lower-stage cushion 20F may be provided.

Further, for example, a configuration in which three or more cushions are arranged on the upper and lower sides may be employed. Further, the shape of each cushion is not particularly limited, and may be formed in a shape other than a rectangular parallelepiped shape.

Further, in the above-described embodiment, as shown in FIG. 2, although eight connecting spring portions 26 are provided, the present disclosure is not limited thereto, and the number of connecting spring portions may be increased or decreased. For example, in a case where the connecting spring portion is formed of resin or the like having lower rigidity than the cushion of the embodiment, the rigidity of the cushion can be increased by reducing the pitch of the connecting spring portion and increasing the number of the connecting spring portions.

Further, in the above-described embodiment, the connecting spring portion having a substantially S-shape when viewed from the sheet width direction is used, and thus the deflection reaction force can be applied, but the present disclosure is not limited thereto, and other configurations may be employed. For example, the cushion body may be formed of a soft material such as urethane foam, and a plate material formed of a hard material such as plastic may be disposed inside the cushion body at an equal pitch, so that a reaction force is applied in an arbitrary direction. In this configuration, the angle of the deflection reaction force can be adjusted by changing the inclination angle of the plate member.

With respect to the above embodiments, the following appendices are disclosed.

### Appendix 1

A seat back body extending in a seat width direction and a seat up-down direction and capable of supporting a back portion of an occupant; and
A central reaction force applying portion provided at a portion where the back portion of the occupant contacts in the seat width direction central portion of the seat back body, and capable of applying a reaction force to the seat upper side with respect to the back portion of the occupant in contact,
Vehicle seat structure having a.

### Appendix 2

The vehicle seat structure according to appendix 1, further comprising an outer reaction force applying portion arranged side by side on both sides in the seat width direction with respect to the central reaction force applying portion and capable of applying a reaction force to the seat lower side with respect to the back portion of the occupant in contact therewith.

### Appendix 3

The vehicle seat structure according to appendix 2, further comprising an upper-stage outer reaction force applying portion that is capable of applying a reaction force to a back portion of the occupant in contact with the seat lower side on a seat upper side of the outer reaction force applying portion of the seat back body.

### Appendix 4

The vehicle seat structure according to appendix 2, further comprising an upper-stage outer reaction force applying portion on a seat upper side of the outer reaction force applying portion of the seat back body, the upper-stage outer reaction force applying portion being capable of applying a reaction force to a seat upper side with respect to a back portion of the occupant in contact therewith.

### Appendix 5

The vehicle seat structure according to any one of appendices 1 to 4, wherein the central reaction force applying portion includes a cushion having an S-shaped cross section as viewed from the seat width direction.

What is claimed is:

1. A vehicle seat structure comprising:
a seat back body extending in a seat width direction and a seat up-down direction and configured to support a back of an occupant; and
a central reaction force applying portion provided at a portion of the seat back body at a center in the seat width direction where the back of the occupant is in contact, and configured to apply a reaction force to the back of the occupant in contact toward a seat upper side.

2. The vehicle seat structure according to claim 1, further comprising outer reaction force applying portions arranged on both sides of the central reaction force applying portion in the seat width direction and configured to apply a reaction force to the back of the occupant in contact toward a seat lower side.

3. The vehicle seat structure according to claim 2, further comprising upper-stage outer reaction force applying portions provided to the seat back body on the seat upper side of the outer reaction force applying portions and configured to apply a reaction force to the back of the occupant in contact toward the seat lower side.

4. The vehicle seat structure according to claim 2, further comprising upper-stage outer reaction force applying portions provided to the seat back body on the seat upper side of the outer reaction force applying portions and configured to apply a reaction force to the back of the occupant in contact toward the seat upper side.

5. The vehicle seat structure according to claim 1, wherein the central reaction force applying portion includes a cushion having an S-shaped cross section as viewed in the seat width direction.
